(19) United States
(12) Patent Application Publication
(10) Pub. No.: US 2023/0353350 A1
(43) Pub. Date: Nov. 2, 2023

(54) DEVICE-INDEPENDENT QUANTUM KEY DISTRIBUTION

(71) Applicants: ETH ZURICH, Zurich (CH); UNIVERSITÄT BASEL, Basel (CH)

(72) Inventors: Melvyn HO, Munich (DE); Pavel SEKATSKI, Binningen (CH); Jean-Daniel BANCAL, Thônex (CH); Nicolas SANGOUARD, Clairefontaine-en-Yevelines (FR); Ernest TAN, Singapur (SG); Renato RENNER, Unterägeri (CH)

(73) Assignees: ETH ZURICH, Zurich (CH); UNIVERSITÄT BASEL, Basel (CH)

(21) Appl. No.: 17/998,661

(22) PCT Filed: May 12, 2021
(86) PCT No.: PCT/EP2021/062585

§ 371 Date: Nov. 13, 2022

(30) Foreign Application Priority Data
May 12, 2020 (EP) 20174086.7

(51) Int. Cl. H04L 9/08

(52) U.S. Cl. CPC H04L 9/0858

(57) ABSTRACT

The invention relates to a method for device-independent quantum key generation and distribution between a first and a second receiver, the method comprising the steps of:
a) Generating an entangled information pair, comprising two entangled quantum moieties that have at least one quantum state entangled with each other, such as a polarization,
b) Transmitting a first entangled quantum moiety of the two entangled quantum moieties to the first receiver (A) and a second entangled quantum moiety of the two entangled quantum moieties to the second receiver (B), and measuring the quantum states of the entangled moieties with a set of selected detection settings chosen randomly at each receiver
c) In a modification step, assigning each measurement value b₁ measured with a detection setting B₁ a complementary value
$${b}_{1}^{∗}$$
according to a noise-probability p, wherein the noise-probability p is larger than 0 and lower than 1, such that a modified plurality of measurement values
$$\tilde{{b}_{1}}$$
is obtained,
d) Generating a final shared quantum key from the modified plurality measurements values
$$\tilde{{b}_{1}}$$
and from a plurality of measurement values a₀ measured with a detection setting A₀ at the first receiver (A).

### SPECIFICATION

The invention relates to a method for device-independent quantum key generation and distribution between a first and a second receiver.

Quantum key distribution (QKD) is well known in the art. One specific kind of QKD with device independent security guarantees which does not require knowledge about any details on the device is the so-called device-independent quantum key distribution.

However, one drawback of device-independent quantum key distribution applications is that the detection efficiency of Alice (A) and Bob (B), i.e. a first and a second receiver that are to generate and distribute the shared quantum key has to be so high (>92%) that practical applications and implementations on consumer devices are almost out of reach. This is for example described in “Pironio, Stefano et al. “Device-Independent Quantum Key Distribution Secure Against Collective Attacks.” New Journal of Physics 11.4 (2009): 045021″.

The present application discloses an elegant and surprising solution for this problem, by providing a method that allows for quantum key distribution at significantly lower detection efficiencies.

The object of the invention is achieved by the method having the features of claim 1.

Advantageous embodiments are described in the subclaims.

According to a first aspect of the invention, a method, particularly a computer-implemented method for device-independent quantum key generation and distribution between a first and a second receiver, comprises the steps of:
a) Generating particularly a single, quantum mechanically entangled information pair, comprising two quantum mechanically entangled quantum moieties, such as photons or other particles that have at least one degree of freedom entangled with each other that can be measured as a quantum state, such as a polarization,
b) Transmitting, particularly via a quantum channel a first entangled quantum moiety of the two entangled quantum moieties to the first receiver (A) and a second entangled quantum moiety of the two entangled quantum moieties to the second receiver (B),
c) At the first receiver (A) receiving and measuring the entangled quantum state of the first entangled quantum moiety with a selected detection setting A* that is chosen from at least three predefined detection settings A₀, A₁, or A₂, wherein a measurement value a₀, a₁, a₂ representative of the outcome of the measurement at the first receiver is stored with and associated to the selected detection setting A*,
d) At the second receiver (B) receiving and measuring the entangled quantum state of the second quantum moiety with a selected detection setting B* that is chosen from at least two predefined detection settings B₁ or B₂, wherein a measurement value b₁, b₂ representative of the outcome of the measurement at the second receiver is stored with and associated to the selected detection setting B*, executing steps e) and f) in arbitrary order,
e) Repeating the steps a) to d) and/or step f), particularly wherein step f) is repeated when step f) precedes step e), such that a plurality of measurement values a₀, a₁, a₂ measured with the associated detection settings A₀, A₁ and A₂, for the measurements at the first receiver (A) is obtained, particularly generated and stored at the first receiver (A) and such that a plurality of the measurement values b₁ and b₂ measured with the associated detection settings B₁ and B₂ for the measurements at the second receiver (B) is obtained, particularly generated and stored, at the second receiver (B),
f) In a modification step, assigning each measurement value b₁ from the plurality of measurement values b₁, when step e) is executed prior to step f) measured with detection setting B₁ with a noise-probability p a complementary value
$${b}_{1}^{*} ,$$
wherein the noise-probability p is larger than 0 and lower than 1, particularly wherein the noise-probability p is larger than 0 and smaller than 0.5,or particularly wherein the noise-probability p is larger than 0.5 and smaller than 1, such that a modified plurality of measurement values
$$\tilde{{b}_{1}^{*}}$$
is obtained after executing step e),
g) Generating a final shared quantum key from the modified plurality measurements values
$$\tilde{{b}_{1}}$$
and from the plurality of measurement values a₀ measured at the first receiver (A).

The invention allows for a lower detection efficiency for the entangled moieties at the first and the second receiver, such that quantum key distribution becomes possible with a lower detection efficiency and a higher quantum key generation rate (which translates in a shorter generation and distribution time). Particularly, the method according to the invention allows for accessing a range of detection efficiencies that are not possible with device-independent key distribution methods known in the art.

The term “detection efficiency” particularly relates to a detection efficiency relating to an overall detection efficiency of the method. For example, the detection efficiency accounts for quantum moiety losses during transmission and a detector efficiency at the first and the second receiver.

Particularly, the noise probability cannot be controlled by the third receiver.

According to another embodiment of the invention, the measurement value b₁ is intrinsically affected by noise such that a true measurement value cannot be obtained. This noise is referred to as intrinsic noise or local noise in the following. Local noise can for example be caused by inherently generated noise by the second receiver, for example by inherent detector noise at the measurement with the detection setting B₁.

While this local noise might be present in almost all measurements, it is noted that in contrast to the art, a noise probability introduced by the local noise, as long as it is known to, i.e. quantifiable by the second receiver, can be accounted for in subsequent method steps for calculation of a correlation value.

In this case (when already the measurement value b₁ is affected by intrinsic noise and the intrinsic noise is known to the second receiver), it is still possible to infer subsequently calculated values, such the correlation value by correcting for the intrinsic noise contribution.

The method according to the invention further provide improved security in case local noise at the second receiver is known and cannot be controlled by a third receiver interfering with the quantum key distribution. Also in this case, a positive key generation rate is obtained with reduced requirement on the detection efficiency.

As long as the key generation rate is positive, the key can be used for various applications such as secure communication between the first and the second receiver. A low key generation rate particularly requires the transmission of more entangled moieties to the first and the second receiver, as compared to a higher key generation rate.

It is known that in device-dependent quantum key distribution methods, noisy preprocessing helps improving a resistance against external noise. However, the inventors surprisingly found that according to the method of invention the modification step f) allows for reducing detection efficiency at the first and the second receiver. This effect is not observed and expected by device-independent quantum key distribution methods.

Furthermore, a reduction of the critical detection efficiency according to the invention from 90.9% (as known in the art) down to 83.2% by executing the method of the invention constitutes a relative tolerance improvement of 78%, i.e. the method almost doubles the admissible imperfections compared to what is known in the art. This in turn allows for a realistic option for realizing device-independent quantum key distribution on every day devices.

In comparison, noise-preprocessing in device independent provides only about 13% relative improvement over know protocols such as BB84.

The inventors were able to derive a technically very difficult fully device-independent security proof that includes the modification step f). Proof techniques aside, the method according to the invention surprisingly reduces the constraints on the detection efficiency as elaborated previously.

A quantum key comprises for example a sequence of bits, particularly referred to as “string”. The quantum key can be used to process data and exchange data securely via a public transmission channel, i.e. a channel that can be recorded by third receivers without the first and the second receiver noticing.

The term “final shared quantum key” particularly refers to the quantum key that might have been modified by additional error correction or privacy amplification protocols and that is known to the first and second receiver.

The entangled information pair particularly consists of two moieties that can be separated spatially.

The term “entangled” as used in the specification particularly relates to a quantum mechanical entanglement of moieties, which in short refers to a situation in which a state of an entangled moiety cannot be described independently without the state of the at least other entangled moiety.

Particularly, at least one degree of freedom of the entangled moieties is entangled. This degree of freedom is for example a polarization, a time bin or frequency bin entanglement, an energy-time entanglement, a path or an orbital angular momentum entanglement.

According to another embodiment of the invention, the entangled moieties are one of photons, electrons, atoms, ions or superconducting Cooper pairs.

According to another embodiment of the invention, the entangled moiety pairs are polarization-entangled photons.

According to an embodiment of the invention, the quantum mechanically entangled moieties are generated by means of spontaneous parametric down-conversion.

Particularly, at least one degree of freedom of the quantum moieties is entangled, wherein the quantum state of the said entangled degree of freedom is measured by the first and the second receiver.

In this sense, the entangled degree of freedom is equivalently referred to as “entangled quantum state” in the current specification.

According to another embodiment of the invention, the entangled moieties are generated at an entanglement source, particularly with an entanglement generating module.

According to another embodiment of the invention, the entanglement source, particularly the entanglement generating module is comprised by the first or the second receiver.

Alternatively, the entanglement source, particularly the entanglement generating module is comprised by an external device that is not comprised by the first or the second receiver.

According to another embodiment of the invention, the entanglement generating module is a quantum network with a plurality of receivers, so-called nodes, wherein the quantum network provides the entangled moieties to the first and the second receiver which are two of its nodes.

In either case, the generated entangled moieties are transmitted at least from the entanglement source, particularly from the entanglement generating module to the first and the second receiver particularly by the quantum channel.

The term “quantum channel” particularly refers to a kind of information transmission, which according to the invention is via entangled moieties. The term quantum channel is particularly used in contrast to the term “public transmission channel” which in turn refers to conventional information transmission, e.g. with radio-wave, or non-entangled photons, i.e. classical light.

Transmission of the entangled moieties can take place in free space directly or via satellite transmission or by means of photonic fibre guidance.

For measuring the state of the first moiety, the first receiver comprises a measurement device configured to measure said state, wherein the first receiver, particularly the measurement device further comprises a detection selector for providing the selected detection setting.

The choice of the detection settings for the first receiver is made randomly, but at least independently from the entanglement source and/or a third receiver. In case, the choice of detection settings is even partially correlated for example to the entanglement source, the security of the quantum key generation and distribution can be corrupted by a third receiver, e.g. an eavesdropper, controlling appropriately the quantum states of the transmitted moieties.

Without loss of generality the measurement values measured at the first receiver associated to the detection setting
A₁ are referred to as a₁,
A₂ are referred to as a₂,
A₀ are referred to as a₀.

Similarly, without loss of generality the measurement values bᵢ measured at the second receiver associated to the detection setting
B₁ are referred to as b₁,
B₂ are referred to as b₂.

The measurement values a₀, a₁, a₂ are stored for example on a memory storage of the first receiver associated to the associated measurement settings A₀, A₁, A₂.

According to another embodiment of the invention, the memory storage of the first receiver is a trusted device or system, e.g. it is not controlled or accessible by a third receiver, e.g. an eavesdropper.

The detection settings A₀, A₁, A₂, B₁ and B₂ each define a measurement basis for the quantum state of the entangled moiety, wherein each detection setting at the first receiver differs from each other and wherein each detection settings B1 and B2 at the second receiver differ from each other.

According to another embodiment of the invention, A₀ and A₁ are detection settings that correspond to two non-identical bases of the quantum state of the first moiety. Particularly, since the method according to the invention is device-independent, it does not rely on a specific implementation of the detection settings. Therefore, the detection settings can be almost arbitrary chosen. An informed choice of the detection settings can be determined according to a later embodiment referring to a correlation value.

According to another embodiment of the invention, the detection settings A₀ and B₁ are used for the key generation, while A₁, A₂ and B₁, B₂ are used for parameter estimation, for the correlation value, such as a later discussed CHSH value.

The choice of the detection setting for the second receiver is made randomly orat least independently from the first receiver, the entanglement source and/or a third receiver. In case, the choice of detection settings is even partially correlated for example to the entanglement source, the security of the quantum key generation and distribution can be corrupted by a third receiver, e.g. an eavesdropper, controlling appropriately the quantum states of the transmitted moieties to the second receiver.

The measurement values b₁, b₂ are stored for example on a memory storage of the second receiver associated to the respective measurement settings B₁, B₂.

According to another embodiment of the invention, the memory storage of the second receiver is a trusted device or system, e.g. it is not controlled are accessible by a third receiver, e.g. an eavesdropper.

According to another embodiment of the invention, the modified plurality measurement values

$$\tilde{{b}_{1}}$$

as well as the plurality of measurement values b₁, are stored for example on a memory storage of the second receiver.

Particularly, the steps a) to d) are repeated more than 100.000 times, particularly more than 1,000,000 times, more particularly more than 10,000,000 times.

Each obtained plurality of the measurement values a₀, a₁, a₂ is particularly an ordered and/or and indexed set of measurement values that is for example sorted according to the time of measurement at the first receiver.

Similarly, each obtained plurality of the measurement values b₁, b₂ as well as the modified plurality of measurement values

$$\tilde{{b}_{1}}$$

is particularly an ordered and/or and indexed set of measurement values that is for example sorted according to the time of measurement at the second receiver.

For sake of clarity it is noted that the plurality of modified measurement values

$$\tilde{{b}_{1}}$$

can comprise non-modified measurement values b₁, as the measurement values b₁ are modified only with a noise-probability p.

Particularly, all measurement values b₁ are stored prior the modification step, such that all original measurement values b₁ are available to the second and particularly to the first receiver. The term “original” refers to the measured measurement value prior to the modification step that might alter the measurement value b₁.

Similarly, the modified plurality is stored at the second receiver such that the modified plurality of measurement values is available to the second and particularly to the first receiver.

The inventors have recognized that surprisingly - noise probabilistically in the key generating measurement results - a secure quantum key distribution is possible which requires a lower detection efficiency. This in turn allows quantum key distribution at less demanding specifications. It is remarkable that while the addition of noise reduces the correlations between the key generating rounds, a lower detection at the first and the second receiver is required for successfully obtaining a quantum key with device-independent security guarantees.

A term “key generating round” particularly refers to the transmission of one entangled quantum moiety pair to the first and the second receiver.

Therefore, the modification step f) is a crucial and particularly distinguishing step of the method over the art.

In this step, noise is applied to the measurement values b₁, wherein said noise particularly flips with the noise-probability p the particularly binary measurement values b₁ to the respective complementary value, e.g. from 0 to 1 or from 1 to 0.

A strength of the noise can be adjusted by adjusting the noise-probability p with which the measurement values b₁ are selected and modified. The noise can therefore be expressed as having the noise-probability p.

According to another embodiment of the invention, the noise-probability is provided and/or transmitted to the second receiver, such that the second receiver knows the noise-probability, particularly such that only the second receiver knows the noise-probability.

According to another embodiment of the invention, the noise-probability p is controlled by the second receiver, particularly only the second receiver.

According to another embodiment of the invention, the noise-probability p comprises a local noise, particularly environmental noise that is for example caused by a detector of the second receiver.

Particularly, the local noise cannot be controlled by the third receiver.

Particularly, the noise-probability comprises a noise component that is adjustable and/or controllable by the second receiver, but particularly not by a third receiver, interfering with the quantum key distribution method.

According to another embodiment of the invention, the noise-probability is adjusted by the second receiver.

It is explicitly noted that it is well within the meaning of claim 1 that step e) and step f) can be merged or the order of the steps e) and f) can be reversed.

Therefore, a first embodiment is for example given by potentially modifying the measurement value b₁ with the noise-probability each time a measurement has been performed with the detection B₁ such that by repeating steps a) to d) and f) the pluralities of measurement values a₀, a₁, a₂, b₁, b₂, and

$$\tilde{{b}_{1}}$$

are obtained.

Alternatively, a second embodiment of the invention is for example given by first repeating the steps a) to d) such that the pluralities of measurement values a₀, a₁, a₂, b₁, and b₂, are obtained and then executing step f) on the plurality of measurement values b₁ such that the modified plurality of measurement values and

$$\tilde{{b}_{1}}$$

is obtained.

Step g) particularly comprises the steps of determining a probability of a third receiver (E) interfering with the transmission of the entangled moieties, an error correction method and a privacy amplification method.

According to another embodiment of the invention, the measurement values a₁ measured with detection setting A₁ and measurement values a₂ measured with detection setting A₂, as well as the measurement values b₁ measured with detection setting B₁ and thus also the modified plurality of measurement values

$$\tilde{{b}_{1}}$$

and measurement values b₂ measured with detection setting B₂ are binary values.

According to another embodiment of the invention, the measurement values a₁ associated to detection setting A₁ are binary values.

According to another embodiment of the invention, the measurement values a₂ associated to detection setting A₂ are binary values.

According to another embodiment of the invention, the measurement values b₁ associated to with detection setting B₁ are binary values.

According to another embodiment of the invention, the measurement values b₂ associated to detection setting B₂ are binary values.

According to another embodiment of the invention, the complementary measurement values

$${b}_{1}^{*}$$

are binary values.

Particularly, any measurement value a₀ for detection setting A₀ is a non-binary value.

According to another embodiment of the invention, the generation of the final shared key comprises executing an error correction method at least on the modified plurality of measurement values

$$\tilde{{b}_{1}}$$

associated to detection setting B₁ and the measurement values a₀ associated to the detection setting A₀ configured to correct any errors from the transmission of the entangled moieties, for example transmission and/or reception errors in the transmission of the entangled moieties to the first and the second receiver, particularly wherein a raw key at the first and the second receiver is obtained after the error correction method is successfully executed.

The error correction method particularly reduces any errors between the information held by the first and the second receiver.

According to another embodiment of the invention, the following steps are executed to determine a probability of a third receiver interfering with the transmission to the entangled moieties to the first and the second receiver via the quantum channel:
Determining for the plurality of measurement values a₁, a₂, and b₁, b₂ a correlation value S, wherein said correlation value S is sensitive to local causality and is further configured to rule out local causality, particularly wherein S configured to be used for a Bell test, particularly wherein the correlation value S is a CHSH coefficient value,
Particularly adjusting the correlation value S for the contribution of the intrinsic noise in the measurement values b₁,
Evaluating the correlation value S, particularly the adjusted correlation value, wherein if said correlation value S is below a predefined threshold value, an alarm will be issued or the first and the second receiver are informed that a third particularly intermediate receiver has interfered with the transmission of the entangled moieties or the transmission noise is too high.

Particularly, the correlation value S is sensitive to locally causal models; under this hypothesis S is bounded by maximum value, e.g. S ≤ 2 in the case of CHSH, which can be exceeded by quantum measurements S > 2 observed during the protocol.

It is noted that the correlation value S is determined from the unmodified measurement values b₁ and particularly not from the modified plurality of measurement values

$$\tilde{{b}_{1}} .$$

However, as noted above, the unmodified measurement values b₁ might be affected by intrinsic noise.

An important reason to compute S is to make sure that a third receiver, e.g. an eavesdropper has not sufficient information for anticipating the final key

According to another embodiment the detection settings A₁, B₁, A₂, and B₂ are chosen such that the correlation value S is maximized.

This embodiment allows making an informed choice regarding the detection settings A₁, A₂, B₁, and B₂.

The measurement values associated to the detection settings A₁, A₂, B₁ and B₂ are used to estimate the correlation value S. The magnitude of the correlation value S particularly provides information on the quality of the entangled state of the entangled moiety pair. Therefore, when each of the entangled moiety pairs is indeed perfectly entangled and the entangled moieties have not lost their entanglement due to environmental factors when arriving at the first or the second receiver, the detection settings A₀ and B₁ may provide identical or at least perfectly correlated measurement values a₀ and b₁.

According to another embodiment of the invention, the generation of the final shared key comprises executing a privacy amplification method at least on the modified plurality of measurement values

$$\tilde{{b}_{1}}$$

and the measurement values a₀ particularly on the raw key, configured to minimize an amount of information possibly available to a third receiver about the final shared quantum key, particularly wherein the privacy amplification method is configured to reduce the amount of information possibly available to a third receiver about the final shared quantum key below predefined threshold value.

According to another embodiment of the invention, if the third receiver interferes with the generation of the final shared quantum key, the method is aborted and/or repeated.

Whether or not the third receiver interferes is for example determined by the correlation value S. Particularly, as long as the first and the second receiver are able to receive some entangled moieties without interference of the third receiver, a final shared quantum key might be generated and distributed.

According to another embodiment of the invention, the detection settings A₀, A₁, A₂ comprise at least two non-identical bases for detecting the quantum state of incident quantum moieties, particularly wherein detection setting A₀ and A₁ form two non-identical bases for detecting the quantum moieties at the first receiver (A).

According to another embodiment of the invention, the detection settings B₁, B₂ comprise at least two non-identical bases for detecting the quantum state of incident quantum moieties.

This embodiment allows the method for example to be executed according to the known E91 protocol (Ekert, Artur K. (5 Aug. 1991). “Quantum cryptography based on Bell’s theorem”. Physical Review Letters. 67 (6): 661-663.) or the BB92 protocol.

According to another embodiment of the invention, the noise-probability p is smaller than 0.3, particularly smaller than 0.2, more particularly smaller than 0.1.

According to another embodiment of the invention, the noise-probability p is larger than 0.7, particularly larger than 0.8, more particularly larger than 0.9.

The optimal value of the noise-probability p for a first and second receiver can be very close to 0, or very close to 1.

For example, in polarization entangled photon applications with detection efficiencies close to 0.9, p might be chosen very close to 1.

For the same setup but detection efficiencies above 0.95, the noise probability p might be chosen very close to 0.

Typically, intermediate values of the noise probability p only correspond to intermediate regimes of detection efficiencies.

According to another embodiment of the invention, the transmitted entangled quantum moieties are detected at the first and/or second receiver (A, B) with a probability lower than 0.95, particularly lower than 0.9, more particularly lower than 0.85.

In the art detection efficiency of the first and the second receiver have to be higher than 0.92 for photonic applications for device-independent quantum key distribution in order to allow any quantum key generation.

According to the invention, the detection efficiency can be lower than in the art, while still allowing for device-independent quantum key generation.

According to another embodiment of the invention, the generated final shared quantum key, is used by the first or the second receiver (A, B) for encrypting an information, wherein the first or the second receiver (A, B) sends the encrypted information, particularly via a public transmission channel, such as by means of radio waves, to the respective other receiver (B, A), i.e. the second or the first receiver, wherein at the second or first receiver (B) the generated final shared quantum key is used to decrypt the received encrypted information.

According to another embodiment of the invention, the generated final shared quantum key, is used by the first or the second receiver (A, B) for authentication of information.

According to a second aspect of the invention, a system is disclosed for device-independent quantum key distribution.

According to this aspect a system for executing the method according to the invention comprises a second receiver (B), wherein the second receiver (B) is configured to
detect incident entangled quantum moieties with at least two different detection setting B₁ and B₂ with a detector of the second receiver,
generate for each measurement a value b₁, b₂ representative for the measurement outcomes preformed with one of the randomly chosen detection setting B₁ or B₂,
store the measurement values b₁, b₂ associated to the randomly chosen detection setting on a data storage of the second receiver,
wherein the second receiver (B) comprises a noise generator, wherein said noise generator is configured modify the measurement values b₁ by introducing noise to measurement values b₁ associated to the detection setting B₁,
particularly store the modified measurement values in the data storage.

The terms and definition disclosed on the context of the method according to the invention are applicable similarly to the system according to the invention.

The noise generator can be a random number generator.

According to another embodiment of the invention, the noise generator is particularly connected to the data storage such as to receive the measurement values b₁ associated to the detection setting B₁ and from the received measurement values b₁ to invert randomly selected measurement values

$${\text{b}}_{1}^{*}$$

of the plurality of measurement values b₁ with a noise-probability p and to store the inverted measurement values

$$\tilde{{\text{b}}_{1}^{*}}$$

and the non-inverted measurement values b₁ as a modified plurality of measurement values

$$\tilde{{b}_{1}}$$

in the data storage.

Particularly, the plurality of measurement values b₁ is not overwritten by the modified plurality of measurement values, but both pluralities are stored and available to the second receiver.

According to another embodiment of the invention, the system comprises
a first receiver (A), wherein the first receiver is connected to the second receiver with a public transmission channel for exchanging information particularly via radio waves, wherein the first receiver is configured to
   a) detect incident entangled quantum moieties with at least three different detection setting A₀, A₁, and A₂ with a detector of the first receiver,
   b) generate measurement values a₀, a₁, a₂ representative for the measurement outcomes preformed with one of the randomly chosen detection setting A₀, A₁, A₂,
   c) store the measurement values associated to the randomly chosen detection setting on a data storage of the first receiver,
an entanglement source configured to generate and distribute entangled, particularly polarization entangled moiety pairs, particularly single entangled moiety pairs, wherein the entanglement source is configured to transmit or distribute a first entangled moiety of the entangled moiety pair to the first receiver and a second entangled moiety of the entangled moiety pair to the second receiver, particularly wherein the entanglement source is a photon source configured to generated entangled photons, particularly polarization entangled photons,
particularly wherein a detection probability for distributed entangled quantum moieties is lower than 0.95, particularly lower than 0.9, more particularly lower than 0.85 at the first and/or the second receiver.

According to another embodiment of the invention, the first receiver comprises an adjustable detection setting device configured to adjust the detection settings to the selected detection setting at the first receiver, wherein the detection setting device comprises for example an optical analyser.

According to another embodiment the first receiver comprises a computer for randomly selecting the detection settings.

According to another embodiment the second receiver comprises a computer for randomly selecting the detection settings.

According to another embodiment of the invention, the second receiver comprises an adjustable detection setting device configured to adjust the detection settings to the selected detection setting at the second receiver, wherein the detection setting device comprises for example an optical analyser.

According to another embodiment of the invention, the first receiver comprises a first detector configured to detect the first moiety.

According to another embodiment of the invention, the first receiver comprises a second detector configured to detect the second moiety.

According to a third aspect a computer program is disclosed that is configured to execute computer-implemented steps of the method according to the invention, when the computer program is executed on a computer, particularly wherein a first computer with the computer program is comprised by and operationally connected to the first receiver and a second computer is comprised by and operationally connected to the second receiver.

According to a fourth aspect of the invention, a method, particularly a computer-implemented method for essentially device-independent quantum key generation and distribution between a first and a second receiver, comprises the steps of:
a) Generating particularly a single, quantum mechanically entangled information pair, comprising two quantum mechanically entangled quantum moieties, such as photons or other particles that have at least one degree of freedom entangled with each other that can be measured as a quantum state, such as a polarization,
b) Transmitting, particularly via a quantum channel a first entangled quantum moiety of the two entangled quantum moieties to the first receiver (A) and a second entangled quantum moiety of the two entangled quantum moieties to the second receiver (B),
c) At the first receiver (A) receiving and measuring the entangled quantum state of the first entangled quantum moiety with a selected detection setting A* that is chosen from at least three predefined detection settings A₀, A₁, or A₂, wherein a measurement value a₀, a₁, a₂ representative of the outcome of the measurement at the first receiver is stored with and associated to the selected detection setting A*,
d) At the second receiver (B) receiving and measuring the entangled quantum state of the second quantum moiety with a selected detection setting B* that is chosen from at least two predefined detection settings B₁ or B₂, wherein a modified measurement value
$${b}_{1}^{*}$$
and/or a measurement value b₂ representative of the outcome of the measurement at the second receiver (B) is stored with and associated to the selected detection setting B*, executing steps e) and f) in arbitrary order, wherein the modified measurement value
$${b}_{1}^{*} ,$$
is affected by noise that corrupts the outcome of the measurement with the detection setting B₂ such that a measurement value b₁ that would have been obtained with the measurement setting B₂ is modified with a noise probability p to a complementary value
$${b}_{1}^{*} ,$$
wherein the noise-probability p is larger than 0 and lower than 1, particularly wherein the noise-probability p is larger than 0 and smaller than 0.5,or particularly wherein the noise-probability p is larger than 0.5 and smaller than 1,
e) Repeating the steps a) to d) such that a plurality of measurement values a₀, a₁, a₂ measured with the associated detection settings A₀, A₁ and A₂, for the measurements at the first receiver (A) is obtained, particularly generated and stored at the first receiver (A) and such that a plurality of the modified measurement values
$$\tilde{{b}_{1}}$$
and a plurality of measurement values b₂ measured with the associated detection settings B₁ and B₂ for the measurements at the second receiver (B) is obtained, particularly generated and stored, at the second receiver (B),
f) Generating a final shared quantum key from the modified plurality measurements values
$$\tilde{{b}_{1}}$$
and from the plurality of measurement values a₀ measured at the first receiver (A).

According to this aspect of the invention, at least the measurement value b₁ is intrinsically affected by noise such that the true measurement value b₁ cannot be obtained. This can for example be caused by inherently generated noise by the second receiver, for example by inherent detector noise at the measurement with the detection setting B₁.

While this local noise might be present in almost all measurements, it is noted that in contrast to the art, the noise probability introduced by the local noise, as long as it is known to, i.e. quantifiable by the second receiver, can be accounted for in subsequent method steps for calculation of a correlation value.

In this case (when only the modified measurement values

$$\tilde{{b}_{1}}$$

and the local noise are known to the second receiver), it is still possible to infer subsequently calculated values, such the correlation value by correcting for the local noise contribution.

Therefore, according to another embodiment of the fourth aspect, the following steps are executed to determine a probability of a third receiver interfering with the transmission to the entangled particles to the first and the second receiver via the quantum channel:
Determining for the plurality of measurement values a₁, a₂, and
$$\tilde{{b}_{1}} ,$$
b₂ a correlation value S, wherein said correlation value S is sensitive to local causality and is further configured to rule out local causality, particularly wherein S configured to be used for a Bell test, particularly wherein the correlation value is a CHSH coefficient value,
Particularly adjusting the correlation value for the contribution of the noise in the modified measurement values
$$\tilde{{b}_{1}} ,$$
Evaluating the correlation value S, particularly the adjusted correlation value S, wherein if said correlation value S is below a predefined threshold value, an alarm will be issued, particularly indicating that there might be a third receiver interfering with the transmission of the quantum moieties or that a transmission noise is too high.

It is noted that all embodiments disclosed for any of the first to third aspect of the invention are also applicable to the fourth aspect of the invention in so far they are adjusted for the influence of the modified measurement values

$$\tilde{{b}_{1}}$$

if necessary.

It is also noted that the methods according to the first aspect and the fourth aspect can be combined such the intrinsic noise (according to the fourth aspect) and noise purposefully added (according to the first aspect) to the measurement values b1 yield the modified measurement values

$$\tilde{{b}_{1}} .$$

The term ‘operationally connected’ denotes a computerized network connection or communication via a network, e.g. a cellular network, wireless network such as radio, Bluetooth or WiFi, a wired network such a Local Area Network (LAN) or Wide Area Network (WAN), as well as a connection via the internet. Particularly, the public channel might be established on a computerized network.

The term “computerized device” or “computerized system” or a similar term denotes an apparatus comprising one or more processors operable or operating according to one or more programs.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

As used herein, the term ‘server’ denotes a computerized device providing data and/or operational service or services to one or more other computerized devices or computers.

The terms ‘software’, ‘program’, or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In the context of embodiments of the present disclosure, by way of example and without limiting, terms such as ‘operating’ or ‘executing’ imply also capabilities, such as ‘operable’ or ‘executable’, respectively.

Particularly, exemplary embodiments are described below in conjunction with the

Figures. The Figures are appended to the claims and are accompanied by text explaining individual features of the shown embodiments and aspects of the present invention. Each individual feature shown in the Figures and/or mentioned in said text of the Figures may be incorporated (also in an isolated fashion) into a claim relating to the device according to the present invention.

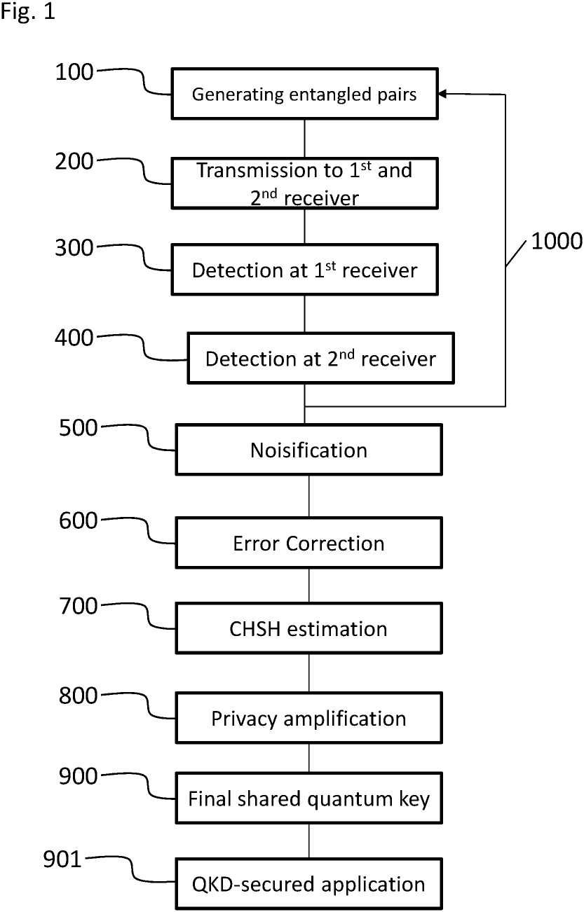

FIG. 1 a flow chart of a first embodiment of the method according to the invention;

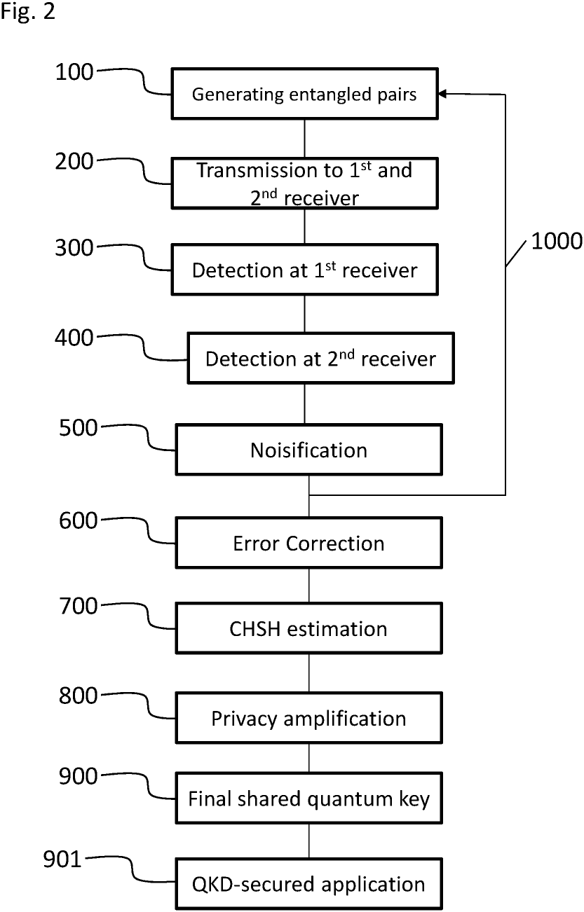

FIG. 2 a flow chart of a second embodiment of the method according to the invention;

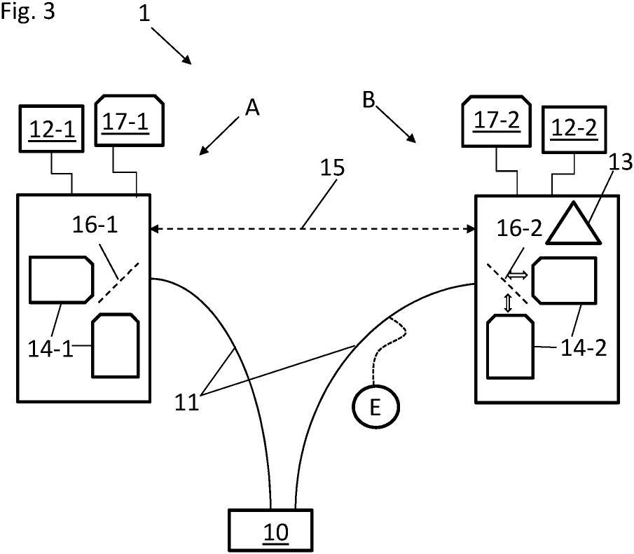

FIG. 3 a first embodiment of a system according to the invention; and

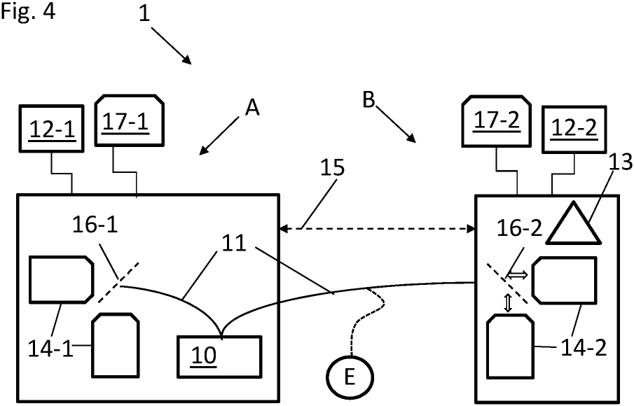

FIG. 4 a second embodiment of a system according to the invention.

In FIG. 1 and FIG. 2 a schematic flow chart for the method according to the invention is shown. Steps a) to d) are identical for both exemplary embodiments shown in FIG. 1 and FIG. 2.

For illustrative purpose the entangled moieties are polarization entangled photons. However, it is explicitly noted that the examples can readily expanded to other entangled moieties and thus are to be understood in a non-limiting way.

In step 100 a polarization-entangled photon pair is generated 100 by an entanglement source 10, for example a spontaneous parametric down-conversions light source.

The entanglement source 10 is particularly configured to produce single photon pairs.

In step 200 a first photon of the entangled photon pair is provided to the first receiver A and a second photon of the entangled photon pair is provided to the second receiver B.

The polarization of the first and the second photon are orthogonal to each other.

At the first receiver A the first photon is detected in a detection step 300 with a first detection efficiency and in a detection step 400 at the second receiver B the second photon is detected with a second detection efficiency.

At the first receiver A, a predefined detection setting A₀, A₁ or A₂ is randomly chosen for measuring the photon’s polarization on a basis that is defined by the respective detection setting. The detection setting is one of A₀, A₁ or A₂. The detection settings A₀, A₁ or A₂ correspond to polarization detection settings that measures the polarization of the photon on three different bases, A₀, A₁, A₂. This is shown in step c) of FIG. 1 and FIG. 2.

The random choice of the detection settings can be done using a random number generator, particularly quantum random number generator.

Similarly, at the detection step 400, at the second receiver B a predefined detection setting B₁ or B₂ is randomly chosen for detecting the photon’s polarization on a basis that is defined by the respective detection setting B₁ or B₂ at the second receiver B. The detection setting B₁ or B₂ at the second receiver B is either B₁ or B₂. The detection settings B₁ or B₂ correspond to polarization detection settings that measure the polarization of the second photon on two different bases B₁, B₂.

A protocol for generating a shared quantum key using said detection settings at the first and the second receiver and the interrelation of the detection settings is for example provided in Stefano Pironio et al. 2009 New J. Phys.11 045021.

The detection settings at the first receiver A are for example selected by means of an independently adjustable optical analyzer 16-1 comprised by the first receiver A. The first receiver A comprises a first detector 14-1 configured and adapted to detect and assign the incident photon after passing the analyzer 16-1 to the measurement value.

The detection settings at the second receiver B are for example selected by means of an independently adjustable optical analyzer 16-2 comprised by the second receiver B. The second receiver B comprises a second detector 14-2 configured and adapted to detect and assign the incident photon after passing the analyzer 16-2 to the measurement value.

For example, the detector setting A₀ corresponds to analyzer settings oriented along

$$\frac{π}{8}$$

and

$$\frac{5 π}{8} ,$$

wherein A₁ corresponds to analyzer settings oriented along 0 and

$$\frac{π}{2} ,$$

wherein A₂ corresponds to analyzer settings oriented along

$$\frac{π}{4}$$

and

$$\frac{3 π}{4} .$$

Accordingly, the detector setting B₁ corresponds to analyzer settings oriented along

$$\frac{π}{8}$$

and

$$\frac{5 π}{8} ,$$

wherein B₂ corresponds to analyzer settings oriented along

$$- \frac{π}{8}$$

and

$$\frac{3 π}{8} .$$

Each time a photon is detected with a randomly chosen detection setting a corresponding measurement value is generated.

For the detection setting A₀ the corresponding measurement value is referred to as a₀. For the detection setting A₁ the corresponding measurement value is referred to as a₁ and for the detection setting A₂ the corresponding measurement value is referred to as a₂. Similarly, at the second receiver for the detection setting B₁ the corresponding measurement value is referred to as b₁ and for the detection setting B₂ the corresponding measurement value is referred to as b₂.

The measurement values are representative for a measured polarization with respect to the chosen detector setting / analyzer 16-1, 16-2 orientation, i.e. with respect to the chosen measurement basis and can be expressed as a binary value indicative for two orthogonal polarization directions.

Each measurement value is stored associated to the corresponding detection setting at the respective receiver A, B.

In FIG. 1 the steps 100 to 400 are repeated 1000 until sufficiently large number of valid measurements are acquired at the first and the second receiver.

After repeating the steps 100 to 400, at the first receiver A there is a plurality of measurement values a₀, a₁, and a₂ obtained and at the second receiver B there is a plurality of measurement values b₁ and b₂ obtained.

In step 500 of FIG. 1 some of the measurement values b₁ are modified. Whether or not a measurement value b₁ is modified is determined by a noise-probability p, i.e. with a noise-probability p each measurement value b₁ is flipped to the opposite binary value, e.g. from 1 to -1 or vice versa.

Thus, a plurality of measurement values b₁ might be composed as follows:

-1, 1, 1, 1, -1, 1, 1.

After the modification step said plurality might be modified as follows:

-1, -1, 1, 1,-1, 1, 1, i.e. the second measurement value is flipped from 1 to -1.

This modified plurality of measurement values is stored at the second receiver as well as the non-modified plurality of measurement values b₁.

The noise-probability p is particularly well-known to the first and the second receiver A, B. Particularly, the noise-probability p has its origin not in random environmental noise present in measurements, storage devices, or other components that accidentally flip measurement values but is introduced to the plurality of measurement values in a controlled fashion.

In contrast, in FIG. 2 the modification step 500 is executed each time a measurement with detection setting B₁ is performed at the second receiver at a detection step 400.

Then, the steps 100 to 400 as well as the modification step 500 are repeated 1000 until a sufficiently large number of valid measurements are acquired at the first and the second receiver A, B.

Apart from this difference the exemplary embodiments in FIG. 1 and FIG. 2 are identical.

In step 600 error correction is performed by executing an error correction method.

The purpose of error correction is to reconcile strings, that are formed by the measurement values a₀, a₁, a₂ as well as b₁, b₂ and/or b*₁ held by the first and the second receiver A, B with as little communication between the first and the second receiver as possible. For example, the first receiver A holds a string a₀ = 00101201 (the string does not need to be a string of bits), and the second receiver B holds the string b₁ = 00101101. These two strings are almost identical, but not perfectly (the 5th position/bit is different in this example). Now, one thing the second receiver B can do is compute the Boolean XOR of a few randomly selected subsets of his string. For instance, if the second receiver selects bits/position [1,2,4,5] for the first subset, i.e. 0001 and [5,6] for the second subset, i.e. 00, the second receiver gets the result (1) for the first subset and (0) for the second subset when applying the XOR operation to the subsets. The second receiver then transmits, via public transmission channel, just these two bits representing the results of the first and the second subset when applying the XOR operation to the first receiver A. With the understanding that these bits are to be interpreted as the result of an XOR operation of the corresponding subsets that are formed by the first receiver, the first receiver can check if the results on his string and the corresponding subsets are identical. In this example, the first receiver would obtain (1) for the first subset of string a₀ and (?) for the second subset of string a₀, wherein the question mark “(?)” indicates that the first receiver doesn’t know what the result is supposed to be. By verifying that the results (1) for the first subsets match, the first receiver gains a high confidence that the bits/positons 1,2,4,5 are correct. The first receiver can then further deduce that the fifth bit should be a 1, so that the results for the second subsets (0) match as well. The first receiver therefore corrects his string to a₀=00101101 which matches the string at the second receiver. Obviously, the person skilled in the art is capable to perform error correction as known in the art. The person skilled in the art knows how to choose the subsets for error correction. For example “https://en.wikipedia.org/wiki/Low-density_parity-check_code” discloses techniques that are available for this task.

After error correction 600, a raw key is obtained/determined from the measurement values a₀ and the modified measurement values b*₁ by the first and the second receiver. The raw key is typically determined by way of comparison of the corresponding measurement values measured at the first and the second receiver, which is a known task for person skilled in the art.

After error correction, step 700 is executed to determine a probability of a third receiver E, Eve, interfering with the transmission to the entangled particles to the first and the second receiver A, B via the quantum channel 11.

For this purpose a correlation value S is determined, wherein said correlation parameter in this example is the so-called CHSH coefficient value (F. Clauser; M.A. Horne; A. Shimony; R.A. Holt (1969), “Proposed experiment to test local hidden-variable theories”, Phys. Rev. Lett., 23 (15): 880-4), that is given by S = 〈a₁b₁〉 + 〈a₁b₂〉 + 〈a₂b₁〉 - 〈a₂b₂〉,

Wherein 〈...〉 denotes the calculation of an expectation value of the quantum correlation between measurement values a and b. With perfectly entangled quantum moieties and detection S will be larger than 2, wherein in case entanglement is broken, e.g. by a third party measuring some or all of the transmitted moieties S will by lower than 2 indicating an interference with the quantum key generation.

In case the correlation value S is below 2 the method might be aborted as the generation of the quantum key might be secure.

A common privacy amplification step 800 is also performed according to some embodiments of the invention. The privacy amplification step 800 allows for reducing an amount of information regarding a string, such as the raw key generated by the first or the second receiver A, B potentially available to a third receiver E below a predefined threshold value.

In the following it is shortly, illustratively and exemplary explained how privacy amplification on the raw key (i.e. a string) of the second receiver B can be performed.

Privacy amplification is accomplished by shortening the raw key. As a simplified example, let’s assume that the second receiver holds the raw (bit) key k₂ = 00101101..., after error correction. It is further assumed that a third receivers amount on each bit of the raw key is smaller than 1, i.e. for the third receiver the probability of having the correct bit value of each bit is ½ < p < 1 per bit. Lastly, it is assumed that the third receiver E has no further information on the raw key. For privacy amplification the second receiver B generates a modified key by applying the BOLLEAN XOR function to successive pairs of bits in the raw key In this case, the modified key would read k₂’ = 0101.... The modified key is twice shorter, and the information of the third receiver on the modified key is reduced. From the third receiver’s point of view, the probability that the first bit is 0 is p² + (1 - p)² < p. The third receiver therefore has less information about the modified key than about the raw key.

In general, information of the third receiver E about the raw can be more general, and more advanced techniques are might be required for privacy amplification. One possibility, which gives rise to universal strong extractor robust to quantum side information, is the multiplication of the raw key with a random Toeplitz matrix M, i.e. defining b′ = M*b. See e.g. Ma, Xiongfeng et al. “Postprocessing for Quantum Random-Number Generators: Entropy Evaluation and Randomness Extraction.” Physical Review A 87.6 (2013).

Once the first and the second receiver A, B have performed privacy amplification the final shared quantum key is obtained 900 after the privacy amplification from the modified key, several quantum key distribution related applications 901 and methods might be based on the final shared quantum key.

FIGS. 3 and 4 schematically show two different embodiments of the system 1 according to the invention.

A first and a second receiver A, B are connected via a so-called quantum channel 11, that is used to transmit the entangled moieties to the first and the second receiver A, B. In this example the entangled moieties are polarization-entangled photon pairs.

The entangled photons are generated by an entanglement source 10 configured to generate and distribute single entangled photon pairs, wherein the source 10 is configured to transmit a first entangled photon of the entangled photon pair to the first receiver A and a second entangled photon of the entangled photon pair to the second receiver B, particularly wherein the entanglement source 10 is a photon source configured to generated entangled photons by a stochastic parametric down-conversion process.

In FIG. 3 the entanglement source 10 is located neither at the location of the first receiver A nor at the location of the second receiver B but at a separate location.

In FIG. 4 the entanglement source 10 is comprised by the first receiver A. Therefore, the first photon pair does not have to propagate far with respect to the first receiver A, but only the second photon has to propagate a comparably long distance.

Both embodiments of the system 1 have distinct advantages.

Regardless of the location of the entanglement source 10, the first receiver A and the second receiver B have a photon detector 16-1, 16-2 for detecting the incident photons from the quantum channel 11.

The detector 16-1, 16-2 can be adjusted by means of an adjustable analyzer 14-2 for at least two detection settings B₁, B₂ at the second receiver B and by means of an adjustable analyzer 14-1 for three detection settings A₀, A₁ or A₂ at the first receiver A. Each detection setting allows measuring the polarization of any incident photon with respect to a predefined basis, e.g. an orthogonal basis. The detection settings are different with respect to their basis, i.e. they use a different basis. Typically, the bases are rotated to by a predefined amount with respect to each other.

The first and the second receiver A, B are further equipped with a module 17-1, 17-2 that is configured to randomly select one detection setting, such that incident photons are measured by a randomly selected detection setting. The module 17-1, 17-2 can be a computer or be comprised in a computer.

The detectors 16-1, 16-2 of the first and the second receiver A, B particularly provide the measurement values in form of a binary number. For this purpose, the detector 16-1, 16-2 might comprise an additional signal transformation module (not shown). Alternatively, the detector signals might be transformed by a computer (e.g. 17-1, 17-2)comprised by the first and the second receiver A, B.

In addition to the known systems for quantum key distribution, the second receiver B has a random number generator 13. The random number generator is configured and adapted as a noise generator, configured to introduce noise to measurement values b₁ associated to the detection setting B₁ of the second receiver B.

The noise can be adjusted in strength, i.e. the noise has an associated noise-probability that determines the probability of each measurement value b1 to be flipped to its complementary value.

For this purpose, the second receiver B is configured to perform a modification step 500 on the measurement values b₁. This modification step 500 can be executed right after a detection event with detection setting B₁ or after transmission of a plurality of measurement values b₁ with detection setting B₁.

In any case, the original measurement values b₁ (particularly the original sequence of measurement values) are stored at the second receiver and also the modified sequence

$$\tilde{{b}_{1}}$$

of measurement values with detection setting B₁.

The modified and the original sequence of measurement values can be very similar depending on the noise probability. For a low noise-probability, the sequences will deviate only in a few instances.

The system 1 is further configured to execute method steps for error correction 600, via a public transmission channel1 5, correlation value S estimation 700 and privacy amplification 800 for generating the final shared quantum key.

Generation of the final quantum key might for example be achieved by using the E91 protocol as described in Ekert, Artur K. (5 Aug. 1991). “Quantum cryptography based on Bell’s theorem”. Physical Review Letters. 67 (6): 661-663.

It is noted that the addition of noise surprisingly allows for a lower detection efficiency of the photons at the detectors such that device-independent quantum key generation can be facilitated in a more robust fashion, while maintaining the same amount of security against third receivers interfering with the quantum key distribution.

1. A method for device-independent quantum key generation and distribution between a first and a second receiver, the method comprising the steps of:
a) Generating (100) an entangled information pair, comprising two entangled quantum moieties that have at least one degree of freedom entangled with each other, such as a polarization,
b) Transmitting (200) a first entangled quantum moiety of the two entangled quantum moieties to the first receiver (A) and a second entangled quantum moiety of the two entangled quantum moieties to the second receiver (B),
c) At the first receiver (A) receiving and measuring (300) the entangled quantum state of the first entangled quantum moiety with a selected detection setting A* that is chosen from at least three detection settings A₀, A₁, or A₂, wherein a measurement value a₀, a₁, a₂ representative of the outcome of the measurement is stored associated to the selected detection setting A*,
d) At the second receiver (B) receiving and measuring (400) the entangled quantum state of the second quantum moiety with a selected detection setting B* that is chosen from at least two detection settings B₁ or B₂, wherein a measurement value b₁, b₂ representative of the outcome of the measurement is stored associated to the selected detection setting B*, executing steps e) and f) in arbitrary order,
e) Repeating (1000) the steps a) to d) and/or f) such that a plurality of measurement values a₀, a₁, a₂ measured with the associated detection settings A₀, A₁ and A₂ for the measurements at the first receiver (A) is obtained at the first receiver (A) and such that a plurality of the measurement values b₁ and b₂ measured with the associated detection settings B₁ and B₂ for the measurements at the second receiver (B) is obtained at the second receiver (B),
f) In a modification step (500), assigning each measurement value b₁ measured with detection setting B₁ a complementary value b1* according to a noise-probability p, wherein the noise-probability p is larger than 0 and lower than 1, such that a modified plurality of measurement values
$$\tilde{{b}_{1}}$$
is obtained after executing step e),
g) Generating (900) a final shared quantum key from the modified plurality measurements values
$$\tilde{{b}_{1}}$$
and from the plurality of measurement values a
₀ measured at the first receiver (A).

2. The method according to claim 1, wherein the measurement values a₁ and measurement values a₂, as well as the measurement values b₁ and measurement values b₂ are binary values.

3. The method according to claim 1, wherein the generation of the final shared key comprises executing (600) an error correction method at least on the modified plurality of measurement values b̃₁ and a₀ configured to correct errors in the transmission of the entangled moieties to the first and the second receiver (A, B), particularly wherein a raw key at the first and the second receiver (A, B) is obtained after the error correction method is successfully executed.

4. The method according to claim 1, wherein the following steps (700) are executed to determine a probability of a third receiver (E) interfering with the transmission to the entangled particles to the first and the second receiver (B) via the quantum channel (11):
Determining for the plurality of measurement values a₁, a₂, and b₁, b₂ a correlation value S, wherein said correlation value S is sensitive to local causality and is further configured to rule out local causality, particularly wherein S configured to be used for a Bell test, particularly wherein the correlation value is a CHSH coefficient value,
Particularly adjusting the correlation value S for a contribution of intrinsic noise in the measurement values b₁,
Evaluating the correlation value S, wherein if said correlation value S is below a predefined threshold value, an alarm is issued and no quantum key is generated.

5. The method according to claim 1, wherein the generation of the final shared key comprises executing (800) a privacy amplification method, at least on the modified plurality of measurement values
$$\tilde{{b}_{1}}$$
and the measurement values a
₀, particularly on the raw key, configured to minimize an amount of information possibly available to a third receiver (E) about the final shared quantum key, particularly wherein the privacy amplification method is configured to reduce the amount of information possibly available to a third receiver about the final shared quantum key below predefined threshold value.

6. The method according to claim 5, wherein if the third receiver (E) interferes with the generation of the final shared quantum key, the method is aborted and/or repeated.

7. The method according to claim 1, wherein the detection settings A₀, A₁, A₂ as well as B₁ and B₂ comprise at least two non-identical bases for detecting the quantum state of incident quantum moieties, particularly wherein detection setting A₀ and A₁ form two non-identical bases for detecting the quantum moieties at the first receiver (A).

8. The method according to claim 1, wherein the noise-probability p is smaller than 0.3, particularly smaller than 0.2, more particularly smaller than 0.1.

9. The method according to claim 1, wherein the noise-probability p is larger than 0.7, particularly larger than 0.8, more particularly larger than 0.9.

10. The method according to claim 1, wherein the transmitted entangled quantum moieties are detected at the first and/or second receiver (A, B) with a probability lower than 0.95, particularly lower than 0.9, more particularly lower than 0.85.

11. A system (1) for executing the method according to claim 1, wherein the system comprises a second receiver (B), wherein the second receiver (B) is configured to
detect incident entangled quantum moieties with at least two different detection setting B₁ and B₂ with a detector (14-2) of the second receiver (B),
generate for each measurement a value b₁, b₂ representative for the measurement outcomes preformed with one of the randomly chosen detection setting B₁ or B₂, store the measurement values b₁, b₂ associated to the randomly chosen detection setting B₁ and B₂ on a data storage (12-2) of the second receiver (B),
wherein the second receiver (B) comprises a noise generator (13), wherein said noise generator (13) is configured to introduce noise to measurement values b₁ associated to the detection setting B₁.

12. The system (1) according to claim 11, wherein the noise generator (13) is configured to receive from the data storage (12-2) or a detector (14-2) from the second receiver (B) the measurement values b₁ associated to the detection setting B₁ and from the received measurement values b₁ to invert randomly selected measurement values
$${b}_{1}^{*}$$
of the plurality of measurement values b
₁ with a noise-probability p and to store the complementary measurement values
$$\tilde{{b}_{1}^{*}}$$
and the non-inverted measurement values b
₁ as a modified plurality of measurement values b̃₁ in the data storage (12-2).

13. The system according claim 11, wherein the system (1) comprises
a first receiver (A), wherein the first receiver (A) is connected to the second receiver (B) with a public transmission channel (15) for exchanging information particularly via radio waves, wherein the first receiver (A) is configured to
a) detect incident entangled quantum moieties with at least three different detection setting A₀, A₁, and A₂ with a detector (14-1) of the first receiver (A),
b) generate measurement values representative for the measurement outcomes preformed with one of the randomly chosen detection setting A₀, A₁, A₂,
c) store the measurement values associated to the randomly chosen detection setting A₀, A₁, A₂ on a data storage (12-1) of the first receiver (A),
an entanglement source (10) configured to generate and distribute entangled moiety pairs, particularly single entangled moiety pairs, wherein the entanglement source (10) is configured to transmit a first entangled moiety of the entangled moiety pair to the first receiver and a second entangled moiety of the entangled moiety pair to the second receiver via a quantum channel (11), particularly wherein the source is a photon source configured to generated entangled photons,
particularly wherein a detection probability for distributed entangled quantum moieties is lower than 0.95, particularly lower than 0.9, more particularly lower than 0.85 at the first and/or the second receiver (A, B).
